(19) United States
(12) Patent Application Publication
(10) Pub. No.: US 2009/0204939 A1
(43) Pub. Date: Aug. 13, 2009

(54) Methods for visual representation of macros language

(76) Inventor: Yuliya Kimovna Lavrova, Cary, NC (US)

Correspondence Address: TRIANGLE PATENTS, P.L.L.C., P.O. BOX 28539, RALEIGH, NC, 27611-8539, US

(21) Appl. No.: 12/069,758

(22) Filed: Feb. 13, 2008

(51) Int. Cl. G06F 9/44

(52) U.S. Cl. 717/105

(57) ABSTRACT

Methods for investigating the source(s) and/or evaluating the source(s) that affect what is impacted by at least one variable within software code, and potential changes thereto. Identification of a variable or modification to code is associated automatically to its source for identifying the potential impact of changing a variable within source code by providing structure and connectivity or impact-based relationships throughout the code.

### BACKGROUND OF THE INVENTION

1. Field of the Invention

The present invention relates generally to software code maintaining. Further, the present invention relates to visualization of software code for investigating transformation and impact of variables using macros representation.

2. Description of the Prior Art

Prior art software code generation and editing typically requires a programmer or developer to use variable or code substitution for efficiently making edits to previously written code. Historically, however, one problem in particular has been overlooked, namely, that of variable substitution and recognition of the substitution after it has been made. While software programs can assist with this, such as word processing software that provides for automated text search and replace functionality, wherein the substitution is easily made, nothing provides for recognition of the text after the substitution. The prior art methods and systems for making and tracking or updating corresponding substitutions are generally static, i.e., they provide two degrees of markers denoting transformations from the initial source, but the result does not equal the initial program. There is no automated means for finding and recognizing connections between the two (resultant changed version and the initial version), in particular for automatically providing the process of generation or transformation for understanding the impact of at least one variable within the program.

Examples of relevant art include:

US Pub. No. 20070209031 for System, Method and Medium for Providing Dynamic Model-Code Associativity providing a system, method and medium that associate source code with a plurality of elements of a model representing the source code. Portions of computer code are associated with one or more of the model elements, wherein when source code is modified to correspond to one or more modified model elements, then at least a portion of the source code that has been modified can optionally be displayed.

Thus, there remains a need to automatically identify and track the relationship between the substitution in software code editing and the initial version or code prior to the editing, modification, or substitution.

### SUMMARY OF THE INVENTION

The systems and methods of the present invention are operable to provide a visual or graphical representation of the connection between the initial and generated code, as well as the process for generation.

A first aspect of the present invention is to provide a method for providing a visual representation of selected part(s) within software code that shows the connections between the initial code and at least one modified version(s) or generated code, including the impact of the modifications from initial to generated code.

A second aspect of the present invention is to provide a method for providing relational indication of how a point of interest exists (or not) in an initial or origination software code and in at least one form of generated software code, and how the transformation of the code impacts the code functionality.

The present invention is further directed to a method for graphically illustrating connections or relationships between modified or generated and initial software code including the steps of parsing the initial code, identifying at least one variable in the code, tracing its location or existence throughout the code and transformations of the code, analyzing the transformation, and presenting results to the user.

The present invention also provides context diagrams for each language of source code related to modifications to that code.

Thus, the present invention provides static and dynamic diagrammatic representation of software code modifications illustrating text changes and runtime changes affected by the modifications.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a static representation of a dynamic display image of a diagrammatic representation of comparative relational code, according to the present invention.

FIG. 2 is a flow diagram showing a processing scheme according to the present invention.

FIG. 3 illustrates a static syntax tree diagram illustrating relational connection between initial code and modified code according to the present invention.

FIG. 4 illustrates a dynamic macro processing tree illustrating runtime changes related to text-based code changes.

### DETAILED DESCRIPTION

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

The present invention provides provide a method for providing a visual representation of modified software code that shows the connections between the initial code and at least one modified version(s) or generated code, and the impact of those modifications.

The systems and methods of the present invention are operable to provide a visual or graphical representation of the connection for a selected variable(s) in all locations it exists between the initial and generated code, as well as the process for generation, thereby providing an indication of impact of the variable selected by the user.

The present invention provides a method for providing a visual representation of selected variable(s) within software code that shows the connections between the initial code and at least one modified version(s) or generated code, including the impact of the modifications from initial to generated code. The present invention also provides a method for providing relational indication of how a variable exists (or not) in an initial or origination software code and in at least one form of generated software code, and how the transformation of the code impacts the code functionality. Automatic graphical representations that are navigable by the user for illustrating connections or relationships between modified or generated and initial software code are provided, including the steps of parsing the initial code, identifying at least one variable in the code, tracing its location or existence throughout the code and transformations of the code, analyzing the transformation, and presenting results to the user. This also includes context diagrams for each language of software code related to modifications to that code. Thus, in doing so, the present invention provides static and dynamic diagrammatic representation of software code modifications illustrating text changes and runtime changes affected by the modifications.

The systems and methods of the present invention are operable to provide a visual or graphical representation of the connection between the initial and generated code, as well as the process for generation. A key part of the present invention is for investigating the sources or evaluating the sources first, before or while evaluating edits to code to understand the impact of a change. The present invention provides first for investigation, for research to get the structure so that the reviewer is provided automatically with information about what happens if one variable is changed, to make sure that nothing else is impacted, or at least whether it is impacted negatively or how it is impacted. Again, it is a key part of the methods and systems of the present invention to provide and ensure automatically that the reviewer is completely aware of what might be impacted if a change is made to the software code, and how the impact will affect the code. Thus, the methods of the present invention provide for automatic collection of all the data that is needed for making a change to the code, and what impact such a change will have on the code. By way of example, state of the art provides that a reviewer can easily find all the places that code or variable A exists by performing a text-based search for A. By contrast, with the present invention, where a reviewer needs to identify and understand the impact of a change to code or variable A, not just a text search locating A automatically, but by automatically providing an analysis of the structure of the software program in addition to understanding where code or variable A exists, it can understand what relationship or connection A has throughout the program, from a source or origination code to a generated code, and then automatically indicate what impact modification to A would have, thereby providing a very deep analysis, beyond a mere text-based search-and-find function, but including also an automatic code syntax analysis, in combination with automatic location identification.

Also, significantly the present invention provides for automatic illustration in graphical representation of the location and impact of code or variable A throughout the software code in such a manner as to show this in a form that the user or reviewer can recognize. The system and methods of the present invention are operable to show the impact and location of code or variable A (and as many as the user selects) and in which term—the initial or origination code or program or the current program. While it is beneficial to diagrammatically view the transformed program, it is important as well to show everything in the terms of the original program. This transformation is a difficult problem that has created a longstanding, unmet need in practice. By way of example, the code or variable A could be transformed in a huge branch of different variables B . . . n, and so it is not easily traceable automatically or manually. However, the system and methods of the present invention provide automatically for showing the process of transformation so that if there is any question why the appearance of the variable A exists in a resulting part, then the systems and methods are operable to automatically trace how and why that selected variable of interest appeared. This automatically traceable information provides significantly deep details about the transformation and impact of the variable within the program—in either direction from source or origination to modification or generated code, and reverse. And the user can selectively see it at any single point with the graphical representation that also provides for functional navigation or automatic tracing movement through the program across the code—again, importantly including the initial code, the generated code, and the process of generation. While in some cases this can be a long process to review, the present invention provides for its automatic availability to the user upon selection of target code or variable to review.

Again, by contrast to the state of the art and/or prior art, the text code may be automatically identified, but the transformation is ignored. In the prior art, the transformation was so huge that they could not do anything without doing something with the transformation first. The present invention has automated the transformation tracing completely, including both the identification of the code or variable location throughout the code, and the impact of the change throughout the code, from initial to generated code. The methods of the present invention apply commonly for any language.

Regarding the visualization for the present invention, there are at least two kinds. One includes the syntax or structure of a program; the second is a type of query for any variable in the program. In either case, the user selects the point and the present invention automatically provides for visualization or diagrammatic representation of the selected variable or code in the original source. In the case where the variable or code only existing in the generated code, then the user still needs information about why it does not exist in original. Importantly, the user needs to know why in order to change something in the code. As a result, there are two structures: one for the original code and the second for the generated code. Thus, the present invention functions to combine all generated points to original for generation. One or many points of the original code can lead to one or many points of generated code. The user will want to know the generation process to understand how to get from initial to generated code. Even if not specifically interested in the process, the user still needs to know it, and it's basically hidden. By not considering and automatically producing and presenting this information, as with the prior art, data is ignored and nothing will be shown for the case where the generated code is not in the original. Thus, the user will be misled by not seeing anything and indications will be that everything with the modification is fine. However, in this example case, if this information is not shown, then it will not indicate that an error exists when it actually does.

Application of the automatic tracing and impact indication of the present invention results in information that a user can determine whether to make or accept an edit in code or not based upon the information. In many of the cases, there will be changes, but not necessarily. With the application of the present invention, the user will be provided automatically with the collected data, analysis of the data, and then an action can be taken or not based upon the information and its graphical representation that illustrates the transformation of the code from origination to generation and reverse from any point within the code. By way of example to illustrate the application of the present invention, the user is provided with a code and considers whether to rewrite the program, or to leave it alone and continue maintaining it. This is applicable for performance and quality review of a program, for example, in considering practically every aspect of the program. The present invention provides automatically for variable traceability and transformation impact and then provides a corresponding visual representation to the user that is navigable between origination code and generated code. These outputs help managers with making decisions about software, and for developers for editing to understand if they make changes what impact those changes will have on the program. Thus, the present invention provides for automatic traceability and transformation impact information for selected variable(s) and code, and to provide corresponding navigable diagrammatic representation of the same, to answer questions about changes or modifications (either made or considered to be made) within software code.

The systems and methods of the present invention are operable to provide a visual or graphical representation of the connection between the initial and generated code, as well as the process for generation. More particularly, in doing so, the present invention provides a software tool for automatically investigating the software program for many aspects, including variable or code traceability and transformation impact, at least automatically providing the initial source code and the generated code and the process for generation. The present invention provides diagrammatic representation or visualization of those three things. In one preferred embodiment, this visualization shows the backlog of the generation in a tree-like form; through the backlog, the present invention provides automatically for connection or relation of every point of initial program to the generated program to answer all questions about the generated code, including impact of selected variable(s) or code.

With application of the methods of the present invention, the user can select or point to the source and see either the structure of the initial program or in the generated program or in the process (ABC). The user can easily navigate from any point to any point (up to 4 points—initial, generated, process, and source) within the visualization provided automatically by the present invention. By way of example, the user can point to a source and then ask what is generated, and then automatically navigate there. The user can see the structure of the initial program and the process of generating program together, to truly understand the impact of a variable within them.

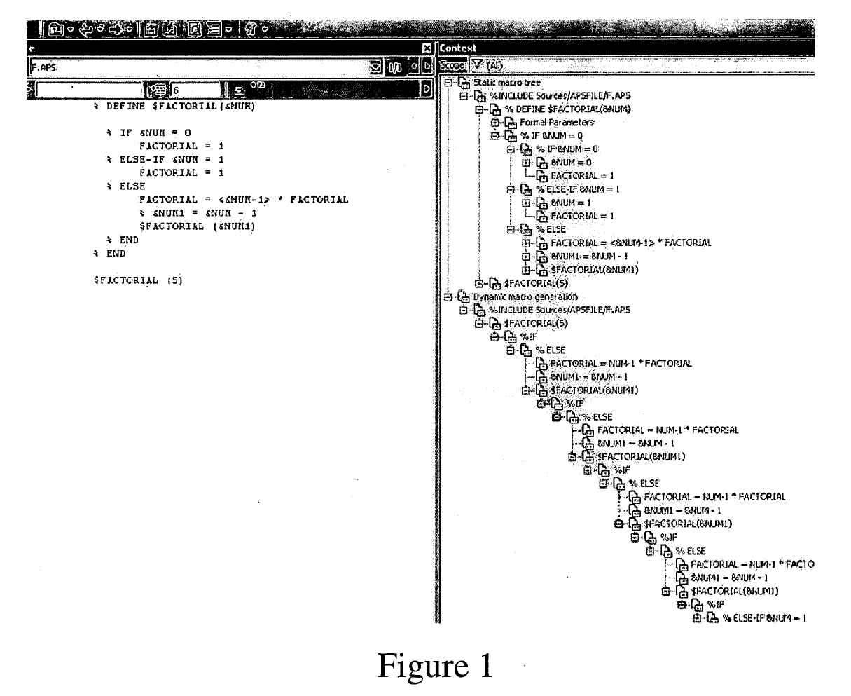

Referring now to the drawings in general, the illustrations are for the purpose of describing a preferred embodiment of the invention and are not intended to limit the invention thereto. As illustrated in FIG. 1, a display image of a diagrammatic representation of comparative relational code, according to one embodiment of the present invention. The left portion of the display image provides a software code relating to the function “define factorial.” The right portion of the display image provides both the static macro tree and dynamic macro generation corresponding to that code from the left portion of the display. The static macro tree diagram provides a hierarchical relational tree diagram providing information on constructions and statements for the target software code; however it provides only information relating to what code is transformed based upon a software code edit, and does not provide information relating to how that code was transformed or edited. For example, it takes text from another file and includes it.

In a step-wise illustration of how the software operates and shows parameters, the macro operates on the same computer as the code editing function. In the foregoing example illustrated in FIG. 1, lines with “%” are not in the resulting text, rather, they indicate connections relating to where the code is generated from, thereby answering any questions relating to tracing the software code modifications, from initial or “source” code prior to any editing, through the modified code.

NOTE to insert the Relativity Modernization Workbench (RMW) example.

With the present invention, a system is operable to run the structure many times, i.e., if the software code line(s) are called a number of times N, then it is generated N times. Importantly, the structure is not only run or generated, but the present invention provides for an indication of where the modified code originated, or comes from (“derives from”), and all possible cross-connections are also indicated. By contrast to the prior art wherein it is not possible to do so, the present invention provides a runtime system shown in a runtime environment. The structure is displayed over the subsystems specific to this system. The user defines something in the code and calls it, and the resulting source (SOBOL) shows how and all possible connection points in the code overall. Again, by contrast to any relevant prior art, the present invention provides an indication of the origination or initial source code prior to the modified or edited code, and in addition provides all of the connection points or cross-connections within the code, which provides an indication of how the change is affected, impacting other code.

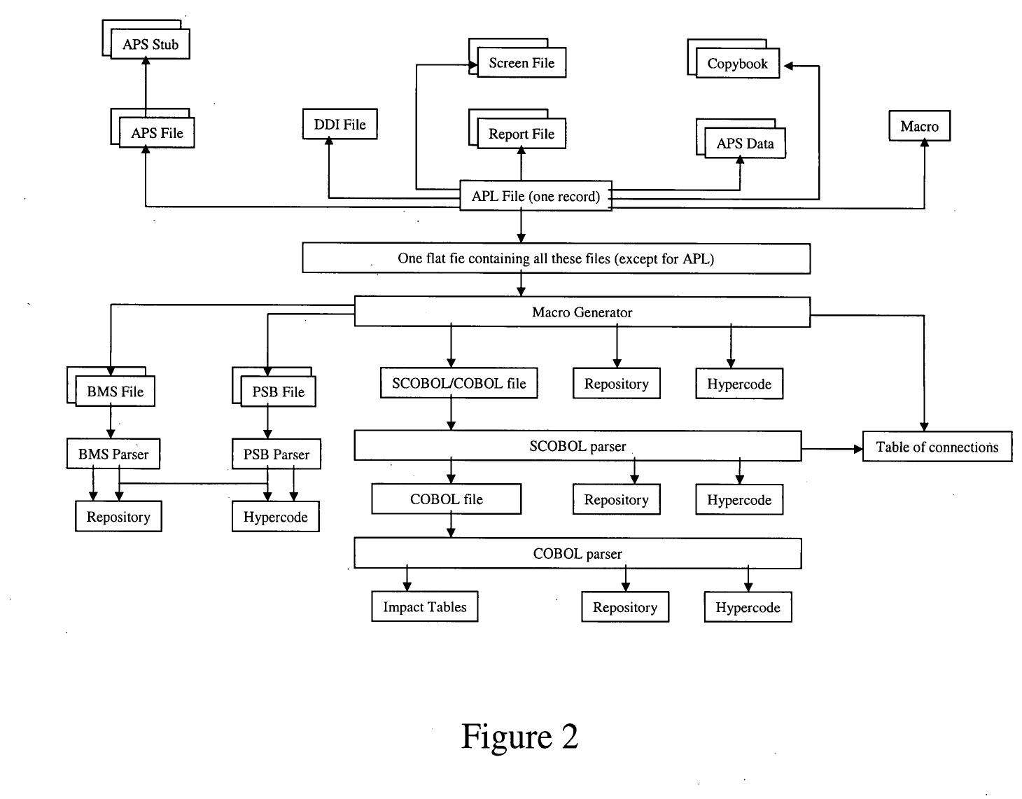

FIG. 2 is a flow diagram showing a processing scheme according to the present invention. Using a complex macro language is difficult to correct or “debug” so a debugging solution was required. Also, the methods of the present invention are useful for writing the macro, as they provide the functional equivalent of a static picture or snapshot of an entire movie, i.e., the static picture of a dynamic process provide a user with the option of moving in either a forward or reverse direction in the code operation from a given point. This enables correction of code defects based upon structure and functionality. The representation being very macro-oriented is helpful, because macros are difficult to work with and normally are generated manually. So for example in a C++ software code language, macros work only inside the parser for the initial source, not the generated source. With the present invention, the macros provide both an original or initial source indication for the target or selected code modification, but also provide an indication of the generated source to which it is related. Thus, the methods of the present invention provide answers to the question of what was modified and how it the modification relates to other code and functions, and how the change is affected, i.e., how it impacts other things.

These initial (origination) and generation connections for a target code are important features of the present invention, since generation of the structure of a change is relatively straightforward; however, the capacity or operational ability to navigate between the structure or specific points within the structure to determine the connection provides much more information to a user working through code modifications.

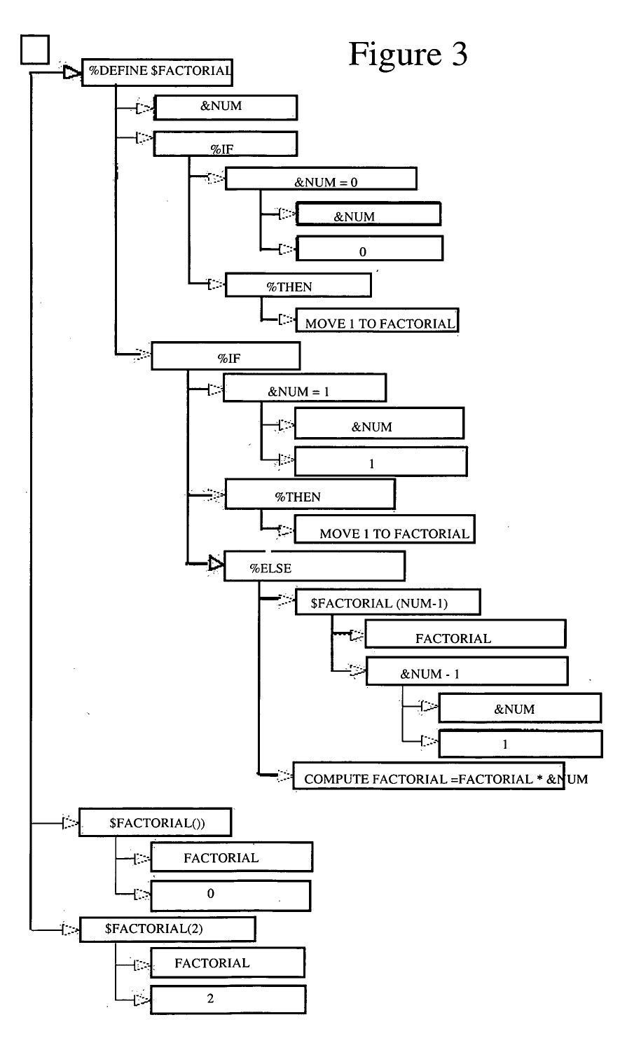

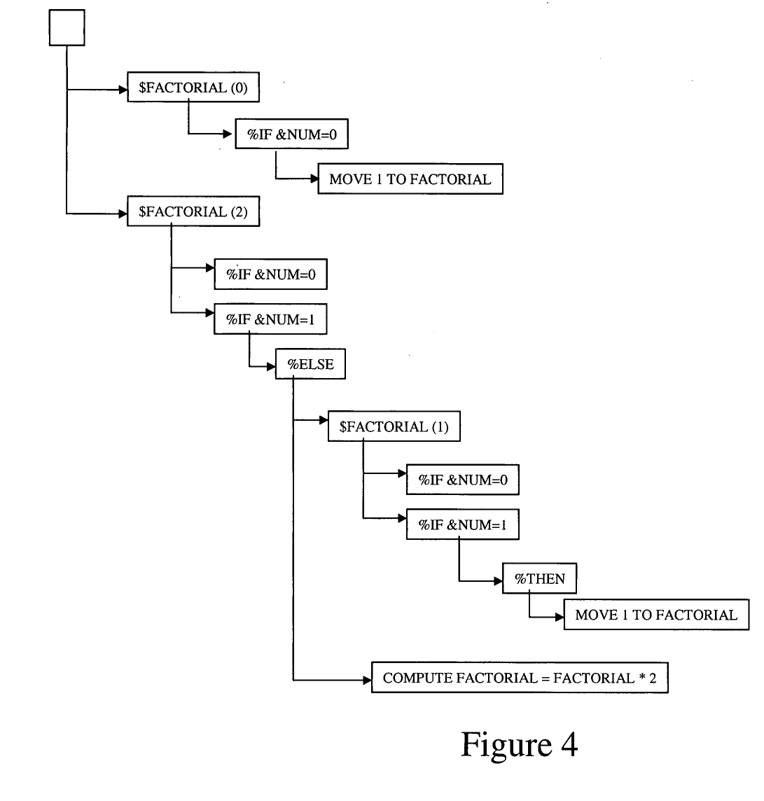

FIG. 3 illustrates a static syntax tree diagram illustrating relational connection between initial code and modified code according to the present invention, and FIG. 4 illustrates a dynamic macro processing tree illustrating runtime changes related to text-based code changes.

If a user is interested in reviewing the initial or originating structure, then macros provide that information with the visual representations shown. If interested in reviewing the generation structure, this is operable in any language. The dynamic nature of the macro is shown as well. The present invention further provides for the user to query any or all of the code. By way of example, when a variable is set, such as var=1, then all places or specific points in the code wherein if the var=1 are visually identified and represented. From this representation, the system is operable for a user to navigate between the structures of the code and the relationships within the code.

NOTE: cross-reference to ABS support document provided by Julia.**

Certain modifications and improvements will occur to those skilled in the art upon a reading of the foregoing description. The above mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the following claims.

What is claimed is:

1. A method for associating software code between versions comprising the steps of:
Providing a computer with software operable thereon, the computer having a display and graphic user interface for visually representing information to a user;
The software operable to automatically trace a variable within the code from an initial code to a generated code, and to automatically indicate the transformation process from initial to generated code.

2. The method of claim 1, further including the step of providing automatically a diagrammatic representation of the connection between the initial and generated code and the process for generation thereof.

3. The method of claim 2, wherein the visualization includes macros.
